(19) United States
(12) Patent Application Publication
(10) Pub. No.: US 2003/0109309 A1
(43) Pub. Date: Jun. 12, 2003

(54) Game system and game control method

(75) Inventor: Jun Fujimoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Aruze Corporation, Tokyo (JP); Seta Corporation, Tokyo (JP)

(21) Appl. No.: 10/282,177

(22) Filed: Oct. 29, 2002

(30) Foreign Application Priority Data
Nov. 1, 2001 (JP) 2001-336537

(51) Int. Cl. A63F 13/00

(52) U.S. Cl. 463/42

(57) ABSTRACT

The present invention includes game machines which, (during processing on participation in a mass game to be executed by a plurality of participant players, prompt the players to use single games other than the mass game, and a mass game unit which starts the mass game upon completion of the processing on participation of the players.

### CROSS REFERENCE TO RELATED APPLICATION

This application is based upon and claims the benefit of priority from the prior Japanese Patent Application No. P2001-336537, filed on Nov. 1, 2001; the entire contents of which are incorporated herein by reference.

### BACKGROUND OF THE INVENTION

1. Field of the Invention

This invention relates to a game system and a game control method for performing processing on a mass game executed by a plurality of participant players.

2. Description of the Related Art

In conventional game halls, various game machines such as race game machines and shooting game machines have been installed. Players can put predetermined amounts of money into the game machines to enjoy desired games. Especially with a race game machine, a number of players participating in the race game can enjoy betting on the order of arrival of horses in a given race.

Each of the players participating in the race game predicts the arrival order of horses installed on a game board and inputs the predicted arrival order of the horses via a control unit before start of a given race. With this, the players can participate in the race game.

Some of the players participating in the race game may promptly predict the arrival order of the horses to run and immediately input the predicted arrival order of the horses far before start of a given race. Those players must have spent with boredom the rest of time before start of the race.

Players having already finished inputting their predicts may desire to play with other game machines (such as shooting games) than the race game to fill the boring time before start of the race. If the boring time before start of the race are just a few minutes, those players should execute games other than the race game (hereinafter referred to merely as “other games”) within the few minutes of time. Under this condition, players will not be much motivated necessarily to play other games even having the boring time.

If the players can execute other games within the boring time and obtain advantageous results (score information such as high marks) from the games, and the race game machine varies dividend rates of the predicted arrival orders based on the obtained score information, the players will be willing to play the other games with positive motivation to fill the boring time.

### BRIEF SUMMARY OF THE INVENTION

The prevent invention has been made to solve the above problems and has an object of providing a game system and a game control method which allow players to play games other than a race game with positive motivation during a boring time before start of the race game, thereby more enjoyably spending the boring time.

More specifically, according to an aspect of the present invention, during processing on participation of a plurality of players in a mass game to be executed by the participating players, game machines allow the players to use single games other than the mass game, and a mass game unit starts the mass game upon completion of the processing on the players' participation.

### BRIEF DESCRIPTION OF THE DRAWINGS

FIG. 1 is a block diagram illustrating the configuration of a game system according to an embodiment of the present invention;

FIG. 2 is a diagram illustrating the contents of game information stored in a use information storage in the embodiment;

FIG. 3 is a block diagram illustrating the configuration of an odds setting unit in the embodiment;

FIG. 4 is a diagram illustrating the contents of a collection list prepared at a collecting unit in the embodiment;

FIG. 5 is a diagram illustrating the contents of a dividend list for use in a multiplier setting unit in the embodiment;

FIG. 6 is a diagram illustrating the contents of multipliers for use in the multiplier setting unit in the embodiment;

FIG. 7 is a diagram illustrating the contents of an additional multiplier list for use in a multiplier varying unit in the embodiment;

FIG. 8 is a diagram illustrating an arrival order decision table for use in a game determiner in the embodiment;

FIG. 9 is a diagram illustrating the contents of game information stored in a game information storage in the embodiment;

FIG. 10 is a diagram illustrating the contents of a discount list for use in a final charge calculator in the embodiment; and

FIG. 11 is a flow diagram illustrating the steps of a game control method according to the embodiment.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Generally and as it is conventional in the representation of devices, it will be appreciated that the various drawings are not drawn to scale from one figure to another nor inside a given figure.

In the following descriptions, numerous specific details are set forth to provide a through understanding of the present invention. However, it will be obvious to those skilled in the art that the present invention may be practiced without such specific details.

[Embodiment]

Configuration of Game System

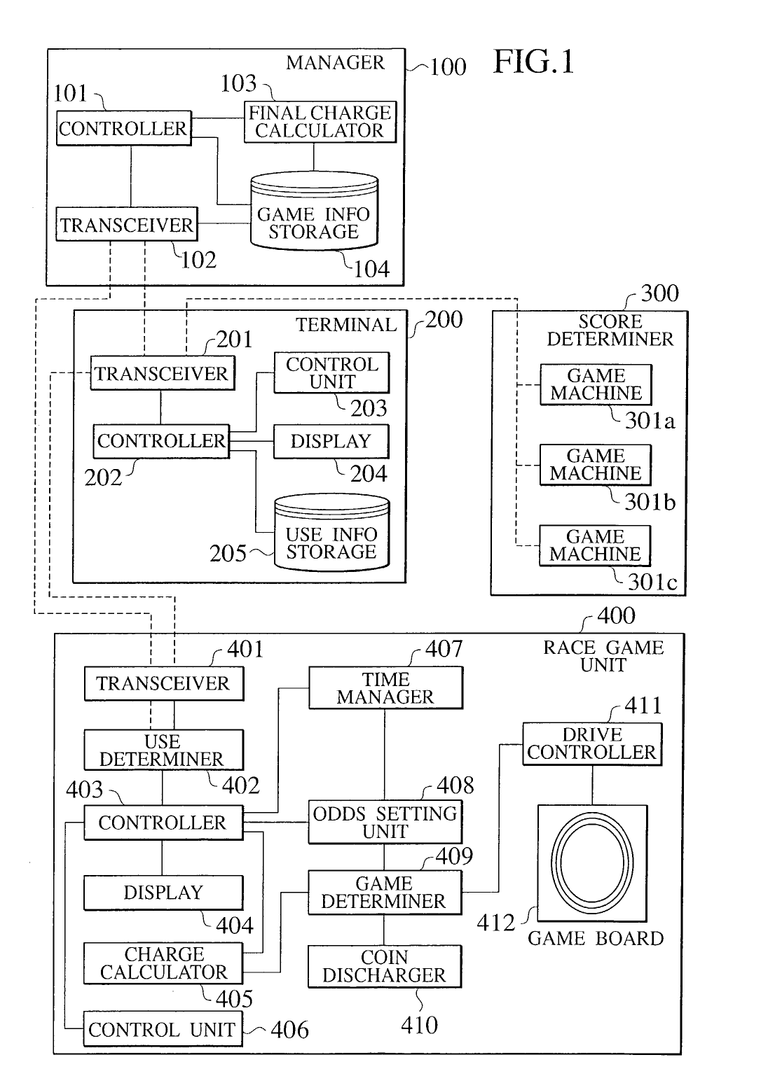

An embodiment of the present invention will be described with reference to the accompanying drawings. FIG. 1 illustrates a block diagram showing the entire configuration of a game system according to the embodiment.

As shown in FIG. 1, the game system operates on a mass game to be executed by a plurality of participant players. The game system includes a race game unit 400 (mass game unit) for starting a mass game after completion of participation processing of a plurality of players, and game machines 301a to 301c to allow the players to use games other than the mass game during the participation processing. Components of a manager 100, a terminal 200, a score determiner 300 and the race game unit 400 can be implemented by a CPU (central processing unit) or hardware.

The terminal 200 obtains an identifier (use ID) for using various game machines (the game machines 301a to 301c and the race game unit 400) from the manager 100 and executes games with the game machines using the obtained identifier. The terminal 200 may be a cellular phone, a PDA or a game terminal, for example. The terminal 200 includes, as shown in FIG. 1, a transceiver 201, a controller 202, a control unit 203, a display 204 and a use information storage 205 in this embodiment.

The transceiver 201 transmits and receives data to and from the manager 100, the score determiner 300 and the race game unit 400. More specifically, when receiving a use request signal (a signal requesting a use ID) from the controller 202, the transceiver 201 transmits the received use request signal to a transceiver 102 in the manager 100.

Upon receiving a use ID in response to the use request signal from the transceiver 102, the transceiver 201 outputs the received use ID to the controller 202. In this embodiment, the player can use all of the game machines in the game hall upon obtaining the use ID from the manager 100.

The controller 202 entirely controls the terminal 200. More specifically, when receiving a use request signal from the control unit 203, the controller 202 outputs the received use request signal to the transceiver 201. Upon receiving a use ID in response to the use request signal from the transceiver 201, the controller 202 stores the received use ID in the use information storage 205.

When receiving game information from the score determiner 300 or the race game unit 400 via the transceiver 201, the controller 202 stores the received game information in the use information storage 205. Here the game information means game-related information players have obtained with the game machines. The game information may include scores obtained in the game machines 301a to 301c or the number of given items (such as characters) obtained by executing games with the game machines 301a to 301c, for example.

The game information may further include charges for players' using the game machines 301a to 301c and the race game unit 400 and the number of coins obtained with the race game unit 400, for example.

When receiving a final charge calculation signal for calculating final charges by use of the game machines from the control unit 203, the controller 202 outputs the received final charge calculation signal to the transceiver 201. Upon receiving the final charge calculation signal from the controller 202, the transceiver 201 transmits the received final charge calculation signal to the transceiver 102.

The control unit 203 inputs data. The control unit 203 may be configured as a joystick control key or a push button control key, for example. The control unit 203 allows the player to control the control unit 203. When controlled to request a use ID, the control unit 203 detects a signal about the control and outputs the detected signal as a use request signal to the controller 202.

When detecting a signal for using one of the various game machines (executing a game), the control unit 203 outputs a game start signal for playing the game with the game machine to the controller 202. Upon receiving the game start signal from the control unit 203, the controller 202 obtains a use ID stored in the use information storage 205 based on the received game start signal. Upon obtaining the use ID, the controller 202 outputs the obtained use ID to the transceiver 201.

Upon receiving the use ID from the controller 202, the transceiver 201 transmits the received use ID to the score determiner 300 or the race game unit 400. The race game unit 400 and the game machines 301a to 301c start games based on the use ID received from the terminal 200.

The display 204 displays the contents of data stored in the use information storage 205. The display 204 may be a liquid crystal display, for example. More specifically, upon receiving a display instruction signal from the controller 202, the display 204 displays the contents of data in response to the received display instruction signal based on the display instruction signal.

For example, upon receiving a use ID from the transceiver 201, the controller 202 outputs a display instruction signal for displaying the obtainment of the use ID to the display 204. Upon receiving the display instruction signal from the controller 202, the display 204 displays information indicating the obtainment of the use ID based on the display instruction signal.

Also, when receiving game information from the score determiner 300 or the race game unit 400 via the transceiver 201, the controller 202 outputs a display instruction signal for displaying the received game information to the display 204. Upon receiving the display instruction signal from the controller 202, the display 204 displays the contents of the game information in response to the received display instruction signal based on the display instruction signal.

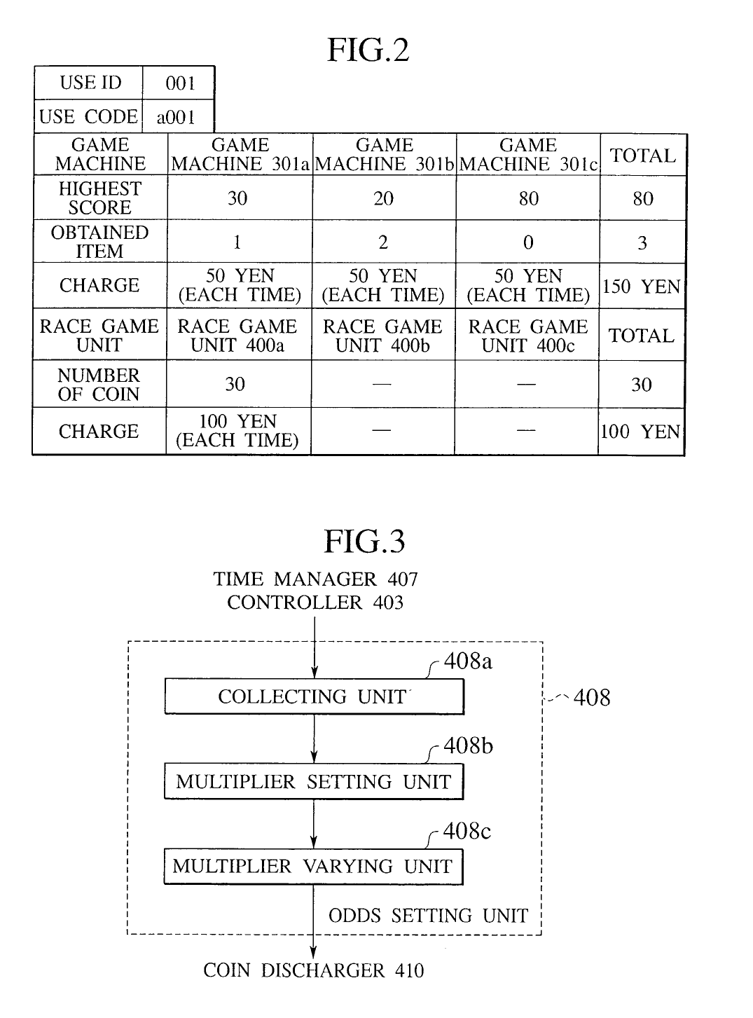

The use information storage 205 stores game information obtained from the score determiner 300 and the race game unit 400. The use information storage 205 may be an IC chip or a hard disk, for example. More specifically, in this embodiment, as shown in FIG. 2, the use information storage 205 stores the highest score obtained with the game machines 301a to 301c (the highest score of 80 among scores obtained in the game machines 301a to 301c).

Also, the use information storage 205 stores the number of items obtained with the game machines 301a to 301c (one item is obtained with the game machine 301a, two items are obtained with the game machine 301b, and that the total number of obtained items is 3) in this embodiment.

Further, the use information storage 205 stores charges for use of the game machines 301a to 301c (50 yen per use in this embodiment and that the total charge is 150 yen) in this embodiment. Furthermore, the use information storage 205 stores the number of coins obtained with game units 400a to 400c (e.g., 30).

In addition, the use information storage 205 stores charges for use of the race game units 400a to 400c (100 yen per use in this embodiment) . The use information storage 205 stores the game information for each use ID (e.g., 001) and each use code (e.g., a001).

A use code is used for varying odds (dividend rates) calculated by the race game unit 400. When game information associated with a use code is good information for the player (e.g., the highest score is great or the number of obtained items is great), the odds setting unit 408 to be described later may vary the ratio of odds (dividend rates) based on the game information associated with the use code. The detail will be described about the odds setting unit 408.

The score determiner 300 is a game machine to allow a player to use a single game other than a mass game before the mass game is started in the race game unit 400. The wording “before the mass game is started” means before time during which participation processing is performed in the race game unit 400 in this embodiment. The score determiner 300 includes, as shown in FIG. 1, the game machines 301a to 301c in this embodiment.

Games other than mass games include single games, for example. Single games include, for example, a shotgun game in which a plurality of bullets are shot out to batter down a target object as a score source and a slot machine in which an agreement is sought from a plurality of figures to have a predetermined game value discharged. Single games further include, for example, a falling object game in which a given object is fallen from higher elevations of a building and a given character receives the fallen object and an auto race game in which a plurality of moving vehicles compete for the arrival order.

The game machines 301a to 301c include determiners (not shown) for determining whether or not the terminal 200 has a specific use ID. The game machines 301a to 301c can thus allow only a player with the terminal 200 having a use ID to use the game machines.

The determiners obtain the use ID from the terminal 200 before the player starts games. The determiners determine whether or not the use ID is managed in the manager 100. When the determination shows that the use ID is managed in the manager 100, the determiners start given games.

The game machines 301a to 301c also include score generators (not shown) for producing given score information ( game information) from execution of single games by a player.

More specifically, when execution of games by a player results in production of given game information, the score generators transmit the produced game information to the terminal 200.

The race game unit 400 is a mass game unit for starting a mass game after the participation of a plurality of players. The race game unit 400 includes, in this embodiment, a transceiver 401, a use determiner 402, a controller 403, a display 404, a charge calculator 405, a control unit 406, a time manager 407, an odds setting unit 408, a game determiner 409, a coin discharger 410, a drive controller 411 and a game board 412. The race game unit 400 will be described in this embodiment as operating on a race game in which a plurality of game elements compete on the game board 412.

The race game unit 400 is not limited to performing a race game with a plurality of game elements competing on a given game board. For example, the race game unit 400 may perform a roulette game in which a plurality of ball halls capable of receiving a ball thrown onto the game board are arranged on the board, the ball halls are individually given identifiers such as numbers or signs, and the ball is received in one of the ball halls. The race game unit 400 may perform a baseball game in which a plurality of baseball players are divided into offensive and defensive sides and the baseball players divided into those sides give an offensive and defensive battle.

The transceiver 401 transmits and receives data to and from the terminal 200 and the manager 100. More specifically, upon receiving the use ID from the transceiver 201 in the terminal 200, the transceiver 401 outputs the received use ID to the use determiner 402. Upon receiving the use ID from the transceiver 401, the use determiner 402 verifies whether or not the received use ID is managed in the manager 100 based on the received use ID. When determining that the received use ID is managed in the manager 100 upon the verification, the use determiner 402 outputs a game start signal for starting a game at the race game unit 400 to the controller 403.

On the contrary, when determining that the received use ID is not managed in the manager 100, the use determiner 402 prevents start of the game to be executed at the race game unit 400. The use determiner 402 transmits an information signal for notifying the impossibility of starting the game to the transceiver 201 via the transceiver 401.

Upon receiving the information signal via the transceiver 201, the controller 202 outputs a display instruction signal to the display 204 for notifying the impossibility of starting the game at the race game unit 400 to the player, based on the received information signal. Upon receiving the display instruction signal from the controller 202, the display 204 displays the notification based on the received display instruction signal.

The display 404 displays the status of the game performed at the race game unit 400. The display 404 may be a liquid crystal display, for example. More specifically, upon receiving a display instruction signal from the controller 403, the display 404 displays the game status in response to the received display instruction signal based on the display instruction signal. Here the game status includes an arrival order list and current odds (multipliers) when the race game unit 400 performs the race game.

The controller 403 entirely controls the race game unit 400. More specifically, upon receiving a game start signal from the use determiner 402, the controller 403 outputs a time fixation instruction signal to the time manager 407 for Fixing the time by which odds (dividend rates) are to be determined, based on the received game start signal.

The time manager 407 controls the time by which dividend rates for arrival orders of game elements to race on the game board 412 are to be determined. The game elements include horse models, for example. More specifically, upon receiving a time fixation instruction signal from the controller 403, the time manager 407 fixes a determining time (e.g., five minutes) by which odds (dividend rates) are to be determined based on the received time fixation instruction signal. Upon fixing the time, the time manager 407 outputs the fixed time as a determination signal to the odds setting unit 408.

The odds setting unit 408 is a score varying unit for varying scores (such as dividend rates) of a mass game based on score information produced in the score determiner 300.

In this embodiment, the odds setting unit 408 includes, as shown in FIG. 3, a collecting unit 408a, a multiplier setting unit 408b and a multiplier varying unit 408c.

The collecting unit 408a prompts players to predict the arrival order of a plurality of game elements to race on the game board 412 and collects the predicted arrival orders of the game elements. More specifically, upon receiving the determination signal from the time manager 407, the collecting unit 408a obtains use IDs (e.g., 001, 002, 003) of players having made entries within the time according to the determination signal and use codes (e.g. a001, a002, a003) corresponding to the use IDs, based on the received determination signal. The use codes are associated with game information.

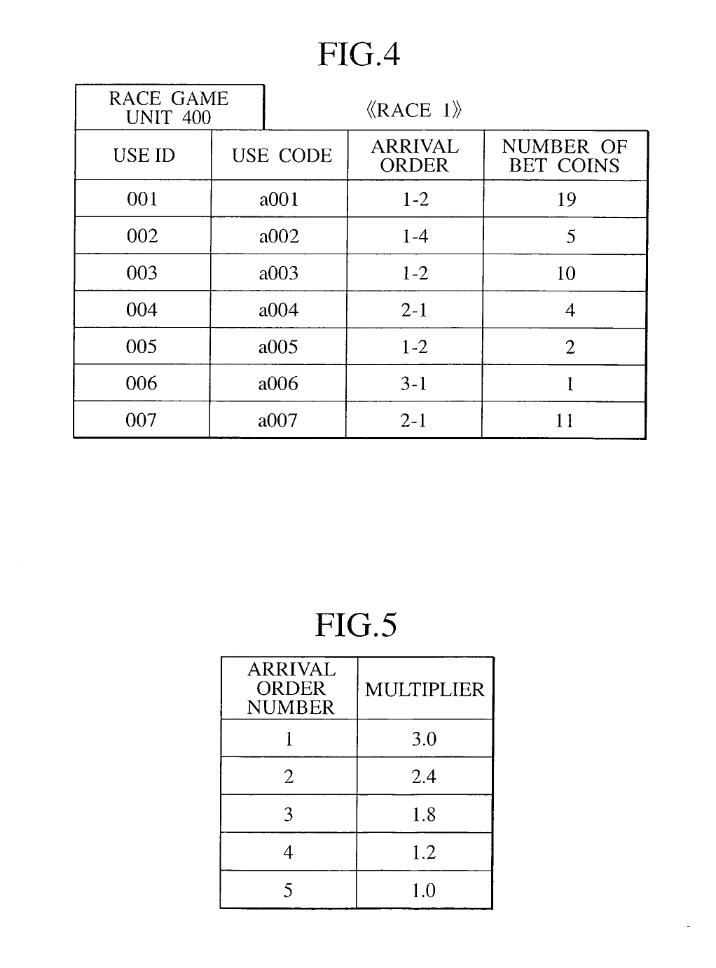

Upon obtaining the use IDs and use codes, the collecting unit 408a collects the horse arrival orders (e.g., 1-2, 1-4, 2-1) predicted by the players corresponding to the use IDs and the numbers of coins (e.g., 19, 5) bet by the players (See FIG. 4). The collecting unit 408a having collected those information outputs the result of collection for each use ID as a collection signal to the multiplier setting unit 408b.

In this embodiment, the use codes once used in a race may be prevented from being used in the next race. In this case, a player having used a use code associated with game information cannot again use the use code used in the past, having increased motivation to obtain another use code associated with game information from the game machines 301a to 301c. As a result, the player can spend meaningful time before start of a race game in the race game unit 400.

Since the use codes are used for varying dividend rates as described above, a player who decides that there is no need Lo vary a dividend rate set at the odds setting unit 408 does not need to obtain a use code from the game machines 301a to 301c.

The multiplier setting unit 408b determines dividends for arrival orders of game elements, based on the collection result at the collecting unit 408a. More specifically, upon receiving a collection signal from the collecting unit 408a, the multiplier setting unit 408b sets odds in response to the received collection signal, based on the collection signal. The multiplier setting unit 408b outputs the set dividend rates (odds) as a dividend signal to the multiplier varying unit 408c.

In this embodiment, the dividend rates are, as shown in FIG. 5, set on the basis of the numbers of identical arrival orders predicted by the players (hereinafter referred to as “arrival order numbers”). The multiplier setting unit 408b assigns the highest dividend rate to the arrival order of the smallest arrival order number (See FIG. 5).

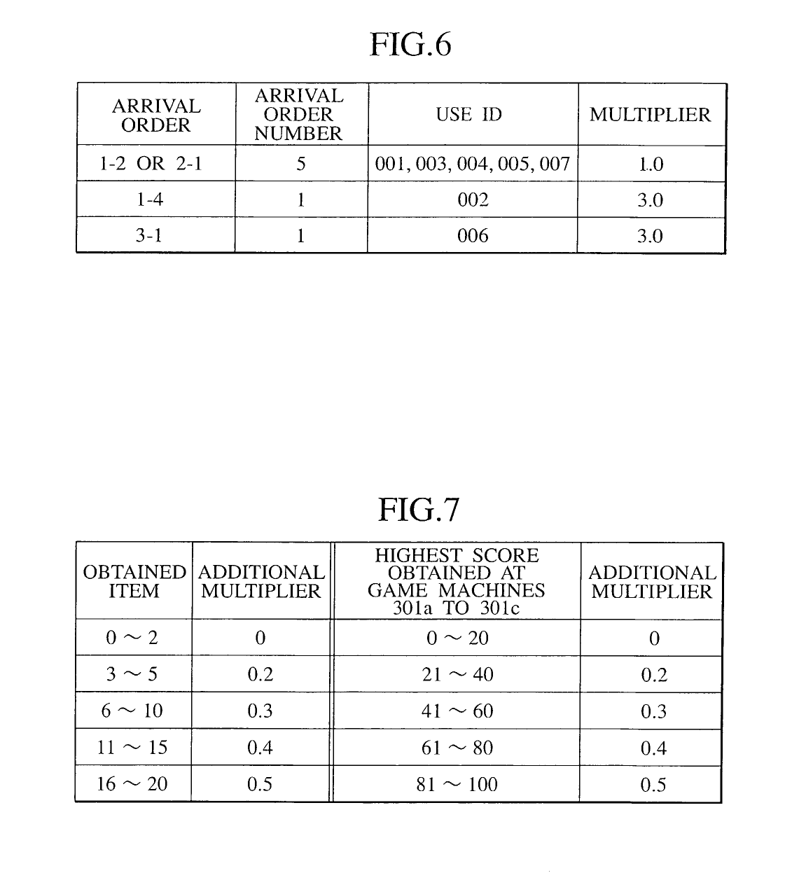

More specifically, the multiplier setting unit 408b calculates, as shown in FIG. 6, the arrival order numbers of identical arrival orders (e.g., 1-2, 2-1) from the arrival order list shown in FIG. 4 (e.g. , the arrival order number is 5 when 1-2 and 2-1 count five). Upon calculation of arrival order numbers, the multiplier setting unit 408b determines dividend rates (multipliers) in proportion to the calculated arrival order numbers based on FIG. 5. The multiplier setting unit 408b determines the dividend rate of 1.0 when the arrival order number is 5.

The multiplier varying unit 408c is a dividend varying unit for varying multipliers (dividends or scores) determined at the multiplier setting unit 408b based on the score information produced by the score determiner 300. More specifically, upon receiving the dividend signal from the multiplier setting unit 408b, the multiplier varying unit 408c varies dividend rates set at the multiplier setting unit 408b based on use codes included in the received dividend signal. For example, when a player having a use ID (001) has made an entry, the multiplier varying unit 408c varies the multiplier of the dividend rate based on the game information in association with the use code (a001) of the use ID (001).

The multiplier to be varied is, as shown in FIG. 7, calculated based on the number of obtained items and the highest score obtained at the game machines 301a to 301c which are included in the game information. When the use code associated with the use ID is a001, the number of obtained items is 3 and the highest score obtained at the game machines 301a to 301c is 80 as shown in FIG. 2. The multiplier varying unit 408c sets an additional multiplier corresponding to the number of obtained items (3) at 0.2, and sets an additional multiplier corresponding to the highest score (80) obtained at the game machines 301a to 301c at 0.4 (See FIG. 7).

The player having the use code of a001 can obtains, as the dividend rate, the multiplier of 1.6 with the calculated additional multipliers of 0.2 and 0.4 added to the dividend rate of 1.0 calculated using the corresponding table in FIG. 5. The multiplier varying unit 408c outputs, as a final multiplier signal, a multiplier with the above additional multipliers added to the dividend rate calculated at the multiplier setting unit 408b to the game determiner 409.

The game determiner 409 has codes successively counted for determining the arrival order of game elements to race on the game board 412. The game determiner 409 extracts a code at a certain point of time from the successively counted codes. The game determiner 409 determines the arrival order of the game elements based on the extracted code.

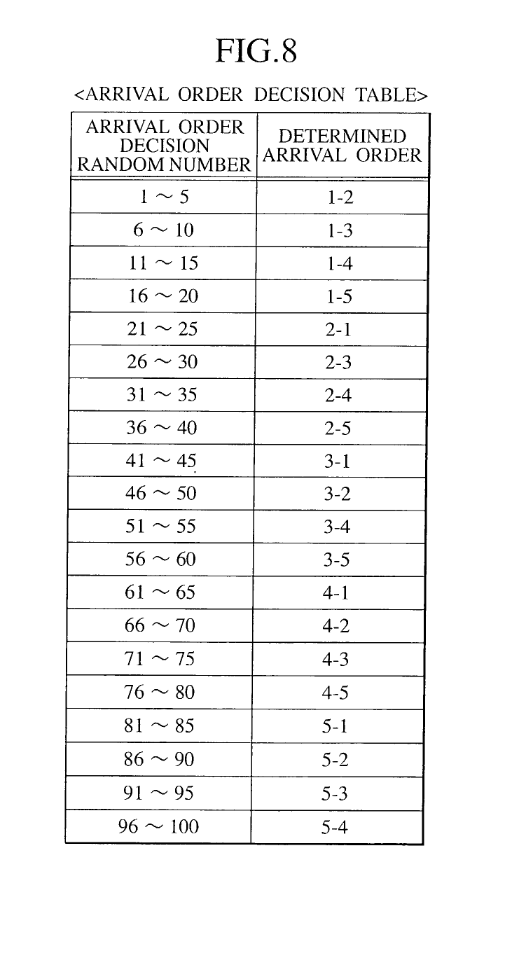

More specifically, upon receiving the final multiplier signal from the multiplier varying unit 408c, the game determiner 409 determines the arrival order of horses to finish the race on the game board 412, using an arrival order decision table shown in FIG. 8. The arrival order decision table comprises arrival order decision random numbers (codes) 1 to 100 in this embodiment.

For example, the game determiner 409 varies the arrival order decision random number (code) successively from 1 to 100 and determines the code (e.g., “3”) at a certain point of time. Upon determining the code (e.g., “3”), the game determiner 409 determines the arrival order (1-2) corresponding to the determined code (“3”).

Upon determining the arrival order, the game determiner 409 outputs to the drive controller 411 a goal signal to make horses corresponding to the arrival order finish the race on the game board 412. Upon receiving the goal signal from the game determiner 409, the drive controller 411 controls based on the received goal signal to make the horses finish the race in response to the goal signal.

The game determiner 409 is also a calculator for calculating game values to be awarded to the players, based on the determined dividends determined at the multiplier setting unit 408b or the multiplier varying unit 408c. More specifically, the game determiner 409 having determined the arrival order determines game values (such as coins) to be awarded to the players based on the determined arrival order and the multiplier corresponding to the determined arrival order (multiplier in response to the final multiplier signal received from the multiplier varying unit 408c).

As shown in FIG. 9, when, for example, the arrival order on which the player corresponding to the use ID (001) has bet is “1-2” and the arrival order determined at the game determiner 409 is “1-2” and the dividend rate corresponding to the arrival order (1-2) determined at the odds setting unit 408 is “1.6,” the game determiner 409 increases the number of coins (19) the player having the use ID (001) has bet to 30 (19×1.6).

Upon calculating the number of coins to be paid out for the player, the game determiner 409 outputs a coin determination signal indicating the final determination of the number of coins to the coin discharger 410 and the controller 403. The game determiner 409 also outputs a finish signal indicating the finish of the race to the charge calculator 405.

The coin discharger 410 discharges a predetermined number of coins for each race conducted on the game board. More specifically, upon receiving the coin determination signal from the game determiner 409, the coin discharger 410 discharges, based on the received coin determination signal, coins in response to the coin determination signal.

The charge calculator 405 calculates charges for each race conducted on the game board. More specifically, upon receiving the finish signal from the game determiner 409, the charge calculator 405 calculates a charge for each use ID included in the finish signal, based on the received finish signal (for example, a charge of 100 yen for each race). Upon calculating charges, the charge calculator 405 outputs the calculated charges as a charge signal to the controller 403.

Upon receiving the coin determination signal and the charge signal from the game determiner 409 and the charge calculator 405, respectively, the controller 403 outputs the received coin determination signal and the charge signal as a race game signal to the transceiver 401. Based on the received race game signal via the transceiver 201, the controller 202 stores the information of charge included in the race game signal and the information of the number of coins discharged at the coin discharger 410 in the use information storage 205 (for each use ID and use code) (See FIG. 2).

The manager 100 manages game information produced at each game machine. The manager 100 includes, in this embodiment, a controller 101, a transceiver 102, a final charge calculator 103, and a game information storage 104.

The transceiver 102 transmits and receives data to and from the terminal 200 and the race game unit 400. More specifically, upon receiving a use request signal from the transceiver 201, the transceiver 102 outputs the received use request signal to the controller 101. Upon receiving a use ID in response to the use request signal from the controller 101, the transceiver 102 transmits the received use ID to the transceiver 201.

The controller 101 entirely controls the manager 100 More specifically, upon receiving the use request signal from the transceiver 102, the controller 101 obtains, based on the received use request signal, a use ID from the game information storage 104 for a player to use the game machines (the race game unit 400 or the game machines 301a to 301c) in the game hall. The controller 101 having obtained the use ID outputs the obtained use ID to the transceiver 102. The controller 101 stores the use status (used/unused) of the use ID and the date of use when the use ID is used in the game information storage 104 (See FIG. 9).

Upon receiving a final charge calculation signal from the transceiver 102, the controller 101 outputs the received final charge calculation signal to the final charge calculator 103. The controller 101 also stores kinds of game machines used by the terminal 200 (such as the game machines 301a to 301c or the race game unit 400) based on game information included in the received final charge calculation signal (See FIG. 9).

The final charge calculator 103 calculates charges for use of the race game and games other than the race game based on the game values calculated at the game determiner 409. More specifically, upon receiving a final charge calculation signal from the controller 101, the final charge calculator 103 calculates charges for use of game machines (the race game unit 400 or the game machines 301a to 301c) used via the terminal 200 based on the game information included in the received final charge calculation signal.

For example, in order for the final charge calculator 103 to calculate charges to a player having the use ID (001), the final charge calculator 103 calculates, based on the game information managed for each use ID (001) shown in FIG, 2, charges included in the game information. In this embodiment, the charge for use of the game machines 301a to 301c is 150 yen and the charge for use of the race game unit 400 is 100 yen. The total charge to the player having the use ID (001) is thus 250 yen.

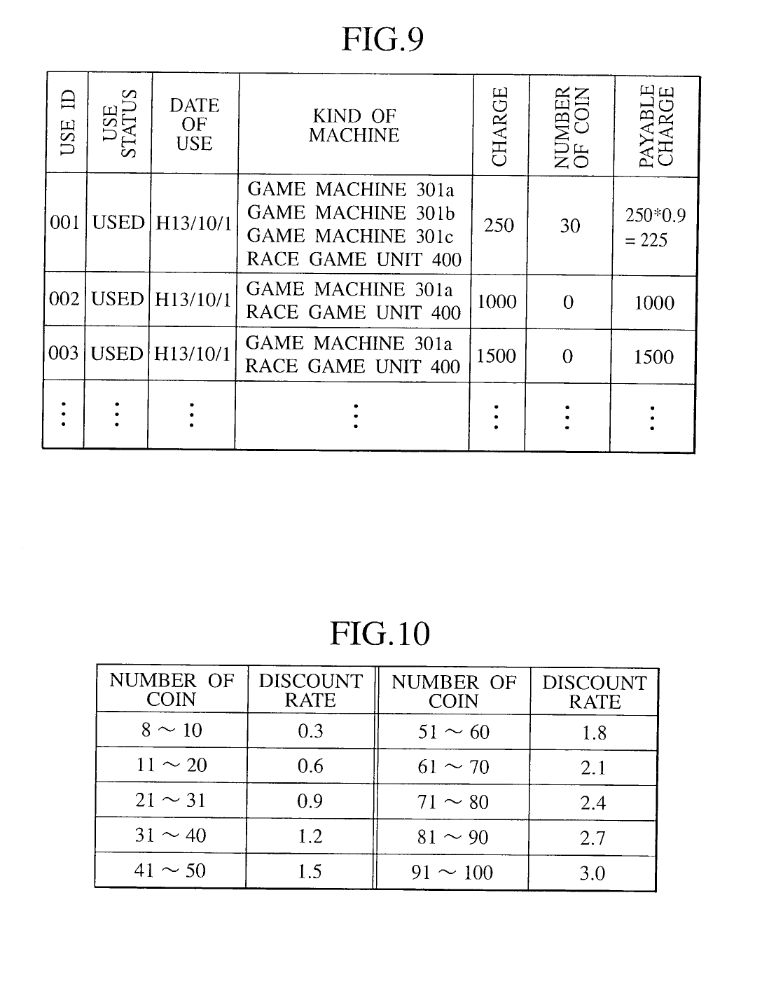

Upon calculating the charge, the final charge calculator 103 determines the discount rate of the charge based on the number of coins included in the game information. For example, the final charge calculator 103 determines the discount rate for the charge to the use ID (001) based on the discount rate in proportion to the number of coins as shown in FIG. 10. The total number of coins of the use ID (001) is 30 as shown in FIG. 2. The discount rate for the use ID is thus 0.9 from the corresponding table shown in FIG. 10.

Upon determining the charge and the discount rate, the final charge calculator 103 multiplies the determined charge by the discount rate to calculate the final charge to be paid by the player having the use ID. For example, the charge to be paid by the use ID (001) is 225 yen with the charge of 250 yen multiplied by the discount rate of 0.9. Upon calculating the charge, the discount rate and the final payable charge, the final charge calculator 103 stores the calculated charge, discount rate and final payable charge in the game information storage 104.

The race game unit 400 may be provided with the use information storage 205 in the terminal 200. The race game unit 400 may also be in wireless or wired connection with the score determiner 300.

This allows the race game unit 400 to directly store the game information obtained at the score determiner 300 in the use information storage 205 provided in the race game unit 400 and eliminates the need for use of the terminal 200 by a player.

Game Control Method Using the Game System

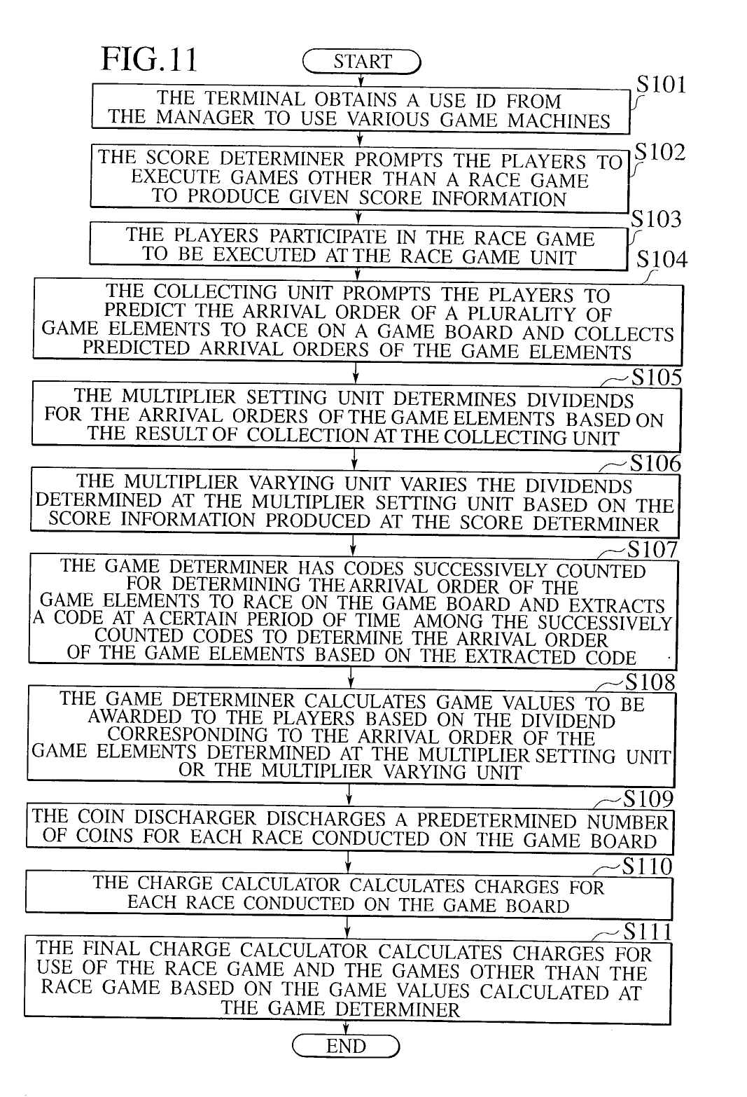

A game control method using the game system having the above configuration can be implemented with the following steps. FIG. 11 is a flow diagram illustrating the steps of the game control method according to the present embodiment.

As shown in the figure, at a first step (S101), the terminal 200 obtains a use ID for using various game machines from the manager 100 More specifically, the control unit 203 controlled by a player to request a use ID detects a signal of the control. The control unit 203 outputs the detected signal as a use request signal to the controller 202 .

Then, the transceiver 102 receives the use request signal from the transceiver 201 and outputs the received use request signal to the controller 101. Upon receiving the use request signal from the transceiver 102, the controller 101 obtains a use ID for the player to use the game machines installed in the game hall from the game information storage 104, based on the received use request signal. The controller 101 outputs the obtained use ID to the transceiver 102. The controller 101 also stores in the game information storage 104 the use status (used/unused) of the use ID and the date of use when the use ID is used (See FIG. 9).

The transceiver 102 receives the use ID in response to the use request signal from the controller 101 and transmits the received use ID to the transceiver 201. Upon receiving the use ID from the transceiver 201, the controller 202 stores the received use ID in the use information storage 205.

At the next step (S102), the score determiner 300 prompts the player to execute single games other than the race game to produce given score information by the games. More especially, when detecting a signal for using the race game unit 400 and the game machines 301a to 301c, the control unit 203 outputs a game start signal to execute games at the game machines 301a to 301c to the controller 202 based on the detected signal. Upon receiving the game start signal from the control unit 203, the controller 202 obtains the use ID stored in the use information storage 205 based on the received game start signal. The controller 202 outputs the obtained use ID to the transceiver 201.

Then, upon receiving the use ID from the controller 202, the transceiver 201 transmits the received use ID to the score determiner 300. The game machines 301a to 301c in the score determiner 300 receive the use ID from the transceiver 201. Upon receiving the use ID, the game machines 301a to 301c determine whether or not the received use ID is managed in the manager 100. When the result of the determination shows that the obtained use ID is managed in the manager 100, the game machines 301a to 301c start games.

Thereafter, when the game execution by the player results in the production of predetermined game information, the game machines 301a to 301c transmit the produced game information to the terminal 200. Here the predetermined game information includes the number of given characters obtained and the highest score obtained by the player using the game machines 301a to 301c as described above. Upon receiving the game information from the score determiner 300 via the transceiver 201, the controller 202 stores the received game information in the use information storage 205.

At the next step (S103), the player participates in the race game to be executed at the race game unit 400. More specifically, the control unit 203 first detects a signal for use of the race game unit 400 and outputs a game start signal for execution of the race game at the race game unit 400 to the controller 202. Upon receiving the game start signal from the control unit 203, the controller 202 obtains the use ID stored in the use information storage 205 based on the received game start signal. The controller 202 outputs the obtained use ID to the transceiver 201.

Then, upon receiving the use ID from the controller 202, the transceiver 201 transmits the received use ID to the transceiver 401. The use determiner 402 receives the use ID from the transceiver 401 and determines whether or not the received use ID is managed in the manager 100.

When the determination result shows that the received use ID is managed in the manager 100, the use determiner 402 outputs a game start signal for start of the game at the race game unit 400 to the controller 403. When the received use ID is not managed in the manager 100, the use determiner 402 prevents start of the game to be executed the race game unit 400. In this case, the use determiner 402 transmits an information signal for notifying the impossibility of start of the game to the transceiver 201 via the transceiver 401.

Upon receiving the information signal via the transceiver 201, the controller 202 outputs a display instruction signal for notifying the player of the impossibility of start of the game at the race game unit 400 Lo the display 204 based on the received information signal. The display 204 receives the display instruction signal from the controller 202 and displays the information based on the received display instruction signal.

At the next step (S104), the collecting unit 408a prompts the player to predict the arrival order of a plurality of game elements to race on the game board 412 and collects the predicted arrival orders of the game elements. More specifically, upon receiving the game start signal from the use determiner 402, the controller 403 outputs a time fixation instruction signal to the time manager 407 for fixing time by which odds (dividend rates) are to be determined based on the received game start signal.

The time manager 407 receives the time fixation instruction signal from the controller 403 and fixes a determining time (e.g., five minutes) by which odds (dividend rates) are to be determined, based on the received time fixation instruction signal. Upon fixing the time, the time manager 407 outputs the fixed time as a determination signal to the collecting unit 408a.

The collecting unit 408a receives the determination signal from the time manager 407 and obtains use IDs (e.g., 001, 002, 003) of players having made entries within the fixed time in accordance with the determination signal and use codes (e.g., a001, a002, a003) corresponding to the use IDs, based on the received determination signal.

Upon obtaining the use IDs and the use codes, the collecting unit 408a collects the horse arrival orders (e.g. 1-2, 1-4, 2-1) predicted by the player shaving the respective use IDs and the numbers of coins (e.g., 19, 5) bet by the players (See FIG. 4). The collecting unit 408a outputs the collected result as a collection signal to the multiplier setting unit 408b.

At the next step (S105), the multiplier setting unit 408b determines dividends for the arrival orders of the game elements based on the result of collection at the collecting unit 408a. More specifically, upon receiving the collection signal from the collecting unit 408a, the multiplier setting unit 408b sets, based on the received collection signal, dividend rates in response to the collection signal. The multiplier setting unit 408b outputs the set dividend rates as a dividend signal to the multiplier varying unit 408c.

In this embodiment, the dividend rates are, as shown in FIG. 5, set based on the numbers of identical arrival orders (arrival order numbers) predicted by the players having made entries. In this embodiment, the multiplier setting unit 408b assigns the highest dividend rate to the arrival order of the smallest arrival order number (See FIG. 5). In this embodiment, the multiplier setting unit 408b determines the dividend rate for each use code.

More specifically, the multiplier setting unit 408b calculates, as shown in FIG. 6, the arrival order numbers of identical arrival orders (e.g., 1-2, 2-1) from the arrival order list shown in FIG. 4 (e.g., the arrival order number of 5 when 1-2 and 2-1 count five). The multiplier setting unit 408b determines dividend rates (multipliers) according to the calculated arrival order numbers based on FIG. 5.

The multiplier setting unit 408b determines, as shown in the same figure, the dividend rate of 1.0 when the arrival order number is 5.

At the next step (S106), the multiplier varying unit 408c varies the dividend rates determined at the multiplier setting unit 408b based on the score information produced at the score determiner 300. More specifically, upon receiving the dividend signal from the multiplier setting unit 408b, the multiplier varying unit 408c varies the dividend rates set at the multiplier setting unit 408b, based on the use codes included in the received dividend signal.

For example, when the player having the use ID (001) has made an entry, the multiplier varying unit 408c adjusts the multiplier of the dividend rate based on the game information associated with the use code (a001) of the use ID (001).

The variation of the dividend rate is, as shown in FIG. 7, calculated based on the number of obtained items and the highest score obtained at the game machines 301a to 301c included in the game information. As shown in FIG. 2, when the use code associated with the use ID is a001 and the number of obtained items is 3 and the highest score obtained at the game machines 301a to 301c is 80, the multiplier varying unit 408c sets an additional multiplier corresponding to the number of obtained items (3) at 0.2 and an additional multiplier corresponding to the highest score (80) obtained at the game machines 301a to 301c at 0.4.

The player having the use code a001 can thus obtain the multiplier of 1.6 as the dividend rate with the additional multipliers 0.2 and 0.4 calculated using the corresponding table in FIG. 7 added to the dividend rate of 1.0 calculated using the corresponding table in FIG. 5. The multiplier varying unit 408c outputs the multiplier with the additional multipliers added to the dividend rate calculated at the multiplier setting unit 408b as a final multiplier signal to the game determiner 409.

At the next step (S107), the game determiner 409 determines the arrival order of the game elements. More specifically, upon receiving the final multiplier signal from the multiplier varying unit 408c, the game determiner 409 determines the arrival order of horses to finish the race on the game board 412 based on the arrival order decision table shown in FIG. 8. The arrival order decision table comprises arrival order decision random numbers (codes) of 1 to 100 in this embodiment.

For example, the game determiner 409 continuously varies the arrival order decision random number (code) from 1 to 100 to determine a code (e.g., “3”) at a certain point of time. Upon determining the code (e.g., “3”) at the point of time, the game determiner 409 determines the arrival order (1-2) corresponding to the determined code (“3”).

Then the game determiner 409 having determined the arrival order outputs a goal signal to the drive controller 411 to make horses finish the race on the game board in the arrival order. The drive controller 411 receives the goal signal from the game determiner 409 and controls the horses to finish the race in accordance with the received goal signal.

At the next step (S108), the game determiner 409 calculates game values to be awarded to the players based on the dividends for the arrival orders of the game elements determined at the multiplier setting unit 408b or the multiplier varying unit 408c. More specifically, upon determining the arrival order, the game determiner 409 determines game values to be awarded to the players based on the determined arrival order and the multiplier corresponding to the determined arrival order (multiplier in accordance with the final multiplier signal received from the multiplier varying unit 408c).

For example, when the arrival order predicted by the player having the use ID (001) is “1-2” and the arrival order determined by the game determiner 409 is “1-2” and the multiplier corresponding to the determined arrival order is “1.6, ” the game determiner 409 increases the number of coins (19) bet by the player having the use ID (001) to 30 (19×1.6). The game determiner 409 outputs a coin determination signal indicating the final determination of the number of coins to the coin discharger 410 and the controller 403. The game determiner 409 also outputs a finish signal indicating the finish of the race to the charge calculator 405.

At the next step (S109), the coin discharger 410 discharges a predetermined number of coins for each race executed on the game board 412. More specifically, upon receiving the coin determination signal from the game determiner 409, the coin discharger 410 discharges coins in response to the received coin determination signal, based on the coin determination signal.

At the next step (S109), the charge calculator 405 calculates charges for each race executed on the game board 412. More specifically, upon receiving the finish signal from the game determiner 409, the charge calculator 405 calculates the charge for each use ID included in the received finish signal, based on the finish signal. The charge calculator having calculated the charges outputs the calculated charges as a charge signal to the controller 403.

The controller 403 receives the coin determination signal and the charge signal from the game determiner 409 and the charge calculator 405, respectively, and outputs the received coin determination signal and the charge signal as a race game signal to the transceiver 401. The controller 202 stores in the use information storage 205 the information of the charges and the information of the number of coins discharged at the coin discharger 410 included in the race game information (for each use ID and use code) based on the race game signal received via the transceiver 201 (See FIG. 2).

At the next step (S111), the final charge calculator 103 calculates the charges for use of the race game and games other than the race game based on the game values calculated it the game determiner 409. More specifically, the control unit 203 controlled by the player detects a signal for calculating charges for use of the various game machines. The control unit 203 outputs the detected signal as a final charge calculation signal to the controller 202.

The final charge calculator 103 having received the final charge calculation signal from the controller 101 calculates the charges for use of the game machines (the race game unit 400 and the game machines 301a to 301c) used via the terminal 200 based on the game information included in the received final charge calculation signal.

For example, in order for the final charge calculator 103 to calculate the charge to the player having the use ID (001), the final charge calculator 103 calculates the charge included in the game information managed for each use ID (001) shown in FIG. 2, based on the game information. In this embodiment, as shown in FIG. 2, the charge for use of the game machines 301a to 301c is 150 yen and the charge for use of the race game unit 400 is 100 yen. The total charge to the player having the use ID is thus 250 yen.

Then, the final charge calculator 103 having calculated the charge determines the discount rate for the charge based on the number of coins included in the game information. More specifically, as shown in FIG. 10, the final charge calculator 103 determines the discount rate in proportion to the number of coins. For example, since the total number of coins of the use ID (001) is 30 as shown in FIG. 2, the discount rate for the use ID is 0.9 from the corresponding table shown in FIG. 10.

Upon determining the charge and the discount rate, the final charge calculator 103 multiplies the determined charge by the discount rate to calculate the final charge to be paid by players having use IDs. For example, the payable charge to the use ID (001) is 225 yen with the charge of 250 yen multiplied by the discount rate of 0.9 as described above. Upon calculating the charge, the discount rate and the final charge, the final charge calculator 103 makes a display (not shown) display the calculated charge, the discount rate and the final payable charge and stores them in the game information storage 104.

Functions and Effects of the Game System and the Game Control Method

According to the present invention, a plurality of players participating in a race game can use game machines with which single games other than the race game can be executed before start of the race game. The players can thus spend meaningful time before start of the race game, using the game machines.

When the players participating in the race game obtain given game information (score information) from the game machines other than the race game unit 400 before start of the race game, the race game unit 400 with which the race game is executed can increase a usual dividend rate using the obtained game information.

More specifically, the multiplier varying unit 408c in the race game unit 400 can increase dividends determined at the multiplier setting unit 408b based on the game information produced at the score determiner 300 serving as the game machines other than the race game unit 400. In particular, the multiplier varying unit 408c can further increase dividend rates determined at the multiplier setting unit 408b when the obtained game information includes items or the like required for increasing the dividend rates.

As a result, a player winning a mass game executed at the race game unit 400 can obtain a predetermined game value with a multiplier higher than a usual dividend rate due to the game information obtained from the other game machines. The player can thus play with the other game machines with positive intensions before the mass game is started. Since the players can use the other game machines with positive intentions, the manager of the game hall can collect more money from the game machines.

The final charge calculator 103 can discount a charge for use of game machines by a player in proportion to the game value obtained by the player. This allows the player to obtain a greater game value and use game machines more with increased positive intensions so as to get discount for the charge.

Further, the multiplier setting unit 408b can determine dividends for arrival orders of game elements in proportion to the numbers of the arrival orders of the game elements on which players bet and set highest the dividend for the arrival order of the game elements on which a smallest number of players bet among the arrival orders of the game elements on which the players bet.

Various modifications will become possible for those skilled in the art after receiving the teachings of the present disclosure without departing from the scope thereof.

What is claimed is:

1. A game system for operating on a mass game executed by a plurality of participant players, comprising:
at least one game machine which allows said players to use a single game other than said mass game during processing on participation of said players in said mass game; and
a mass game unit configured to start said mass game upon completion of said participation processing.

2. A game system as set forth in claim 1, wherein:
said game machine includes a score generator for producing given score information from execution of said single game by said players; and
said mass game unit includes a score varying unit for varying scores of said mass game based on said score information produced by said score generator.

3. A game system as set forth in claim 2, wherein said mass game is a race game in which a plurality of game elements race on a given game board.

4. A game system as set forth in claim 3, wherein said mass game unit further including:
a collecting unit for prompting said players to predict the arrival order of said game elements to race on said game board and collecting predicted arrival orders of said game elements; and
a dividend determiner for determining dividends for said arrival orders of said game elements, based on the result of collection at said collecting unit.

5. A game system as set forth in claim 4, wherein said mass game unit further includes a dividend varying unit for varying said dividends determined by said dividend determiner based on said score information produced by said score generator.

6. A game control method for performing processing on a mass game executed by a plurality of participant players, said method comprising the steps of:
prompting, at at least one game machine, said players to use a single game other than said mass game during processing on participation of said players in said mass game; and
starting, at a mass game unit, said mass game upon completion of said participation processing.

7. A game control method as set forth in claim 6, further comprising the steps of:
producing, at said game machine, given score information from execution of said single game by said game players; and
varying, at said mass game unit, scores of said mass game based on said produced score information.

8. A game control method as set forth in claim 7, wherein said mass game is a race game in which a plurality of game elements race on a given game board.

9. A game control method as set forth in claim 8, further comprising the steps of:
prompting, at said mass game unit, said players to predict the arrival order of said game elements to race on said game board and collecting predicted arrival orders of said game elements; and
determining, at said mass game unit, dividends for said arrival orders of said game elements, based on the result of collection of said arrival orders of said game elements.

10. A game control method as set for thin claim 9, further comprising the step of varying, at said mass game unit, said determined dividends based on said produced score information.
